(19) United States
(12) Patent Application Publication
(10) Pub. No.: US 2024/0334150 A1
(43) Pub. Date: Oct. 3, 2024

(54) SOUND EFFECT PROCESSING METHOD, DEVICE, AND STORAGE MEDIUM DEVICE

(71) Applicant: Lenovo (Beijing) Limited, Beijing (CN)

(72) Inventor: Wentao SUN, Beijing (CN)

(21) Appl. No.: 18/606,717

(22) Filed: Mar. 15, 2024

(30) Foreign Application Priority Data
Mar. 31, 2023 (CN) 202310344018.2

(51) Int. Cl. H04S 7/00; G06T 7/60; G06T 11/00; G06V 10/764

(52) U.S. Cl. CPC H04S 7/305; G06T 7/60; G06T 11/00; G06V 10/764

(57) ABSTRACT

A sound effect processing method includes obtaining information of a real object. The information includes an association relationship between the real object and a virtual scene and an acoustic property of the real object. The method further includes determining a sound output effect of the virtual scene based on the information of the real object and outputting sound of the virtual scene based on the sound output effect.

### CROSS-REFERENCE TO RELATED APPLICATION

The present disclosure claims priority to Chinese Patent Application No. 202310344018.2, filed on Mar. 31, 2023, the entire content of which is incorporated herein by reference.

### TECHNICAL FIELD

The present disclosure relates to the sound effect processing technology field and, more particularly, to a sound effect processing method, a sound effect processing device, and a storage medium.

### BACKGROUND

When the existing augmented reality (AR) product runs an application such as a game, a user can see a scene after fusing a real environment and a virtual object, not a purely virtual environment. A sound effect of a sound that is played back is obtained by merely performing sound effect calculations according to the position of the virtual object in the virtual scene and a surface property. The sound effect cannot be adjusted in connection with an actual object in the real scene. Thus, the immersion feeling of the user in the AR scene is reduced, which leads to poor realism in the virtual environment.

### SUMMARY

An aspect of the present disclosure provides a sound effect processing method. The method includes obtaining information of a real object. The information includes an association relationship between the real object and a virtual scene and an acoustic property of the real object. The method further includes determining a sound output effect of the virtual scene based on the information of the real object and outputting sound of the virtual scene based on the sound output effect.

An aspect of the present disclosure provides a sound effect processing device, including one or more processors and one or more memories. The one or more memories stores a computer instruction that, when executed by the one or more processors, causes the one or more processors to obtain information of a real object, determine a sound output effect of the virtual scene based on the information of the real object, and output sound of the virtual scene based on the sound output effect. The information includes an association relationship between the real object and a virtual scene and an acoustic property of the real object.

An aspect of the present disclosure provides a storage medium storing a computer program that, when executed by one or more processors, causes the one or more processors to obtain information of a real object, determine a sound output effect of the virtual scene based on the information of the real object, and output sound of the virtual scene based on the sound output effect. The information includes an association relationship between the real object and a virtual scene and an acoustic property of the real object.

### BRIEF DESCRIPTION OF THE DRAWINGS

FIG. 1 illustrates a schematic flowchart of a sound effect processing method according to some embodiments of the present disclosure.

FIG. 2 illustrates a schematic diagram showing a virtual scene corresponding to a sound effect processing method device according to some embodiments of the present disclosure.

FIG. 3 illustrates a schematic flowchart of a sound effect processing method according to some embodiments of the present disclosure.

FIG. 4 illustrates a schematic flowchart of a sound effect processing method according to some embodiments of the present disclosure.

### DETAILED DESCRIPTION OF THE EMBODIMENTS

Various technical solutions and features of the present disclosure are described here in connection with the accompanying drawings.

Various modifications can be made to embodiments of the present disclosure. The present specification is not considered as limiting but merely as examples of embodiments of the present disclosure. Those skilled in the art will think of other modifications in the scope and spirit of the present disclosure.

The drawings included in the specification and forming a part of the specification illustrate embodiments of the present disclosure. The drawings are used to describe the principles of the present disclosure with the general description and the detailed description of embodiments of the present disclosure.

Features of the present disclosure will become obvious through the description of preferred forms of embodiments that are not limiting with reference to the accompanying drawings.

Although the present disclosure is described according to some examples, those skilled in the art can implement many other equivalent forms of the present disclosure.

In connection with the accompanying drawings, the above and other aspects, features, and advantages of the present disclosure will become more obvious with the detailed description.

Embodiments of the present disclosure can be described with reference to the accompanying drawings. However, embodiments of the present disclosure are examples of the present disclosure and can be implemented in many methods. Well-known and/or repeated functions and structures are not described in detail to avoid obscuring the present disclosure with unnecessary or redundant detail. Thus, structural and functional details of the present disclosure are not intended to limit the present disclosure but merely used as a basis and representative basis of the claims, which are used to teach those skilled in the art to use the present disclosure with any appropriate detailed structure.

In the present specification, phrases such as “in one embodiment,” “in another embodiment,” “in yet another embodiment,” or “in other embodiments,” can refer to one or more of the same or different embodiments of the present disclosure.

Embodiments of the present disclosure provide a sound effect processing method. The sound effect processing method can be applied to an electronic apparatus. The electronic apparatus can include but is not limited to a laptop, a smart phone, and a smart wearable apparatus. For example, the electronic apparatus can be an augmented reality apparatus, such as AR glasses.

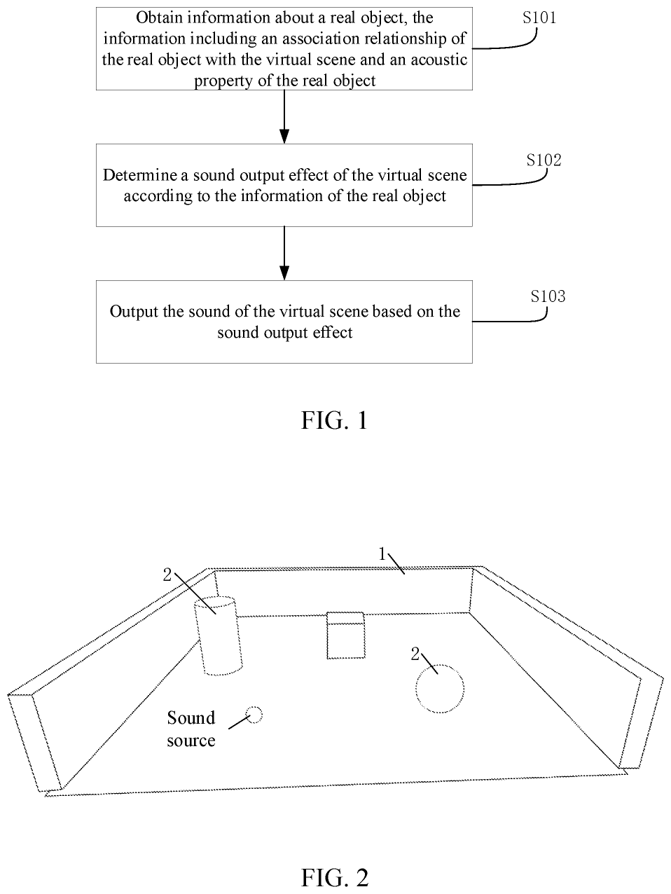

Furthermore, as shown in FIG. 1, the sound effect processing method includes steps S101 to S103.

At S101, information about real object 1 is obtained. The information includes an association relationship of the real object 1 with the virtual scene and an acoustic property of real object 1.

In some embodiments, real object 1 can be an object that exists in the real environment. For example, real object 1 can be an object of the real environment that needs to be integrated by the AR glasses when the user wears the AR glasses. As shown in FIG. 2, the wall is the real object.

In some embodiments, the virtual scene can be a scene generated by integrating real object 1 of the real environment and virtual object 2. The association relationship of real object 1 and the virtual scene can at least include a coordinate of real object 1 in the virtual scene and a relative position relationship of real object 1 and virtual object 2. Virtual object 2 can include a virtual object such as a column and a ball constructed in the virtual scene.

For example, FIG. 2 shows a schematic diagram of a virtual scene. The virtual scene includes real object 1, virtual object 2, and a sound source. The sound source can be a sound emitted by an object or play, such as stereophonic sound, which is not limited in the present disclosure as long as the sound can be emitted.

In some embodiments, the acoustic property of real object 1 can include one or more of pitch, loudness, timbre, and an acoustic parameter that affects at least one of the pitch, loudness, or timbre.

At S102, a sound output effect of the virtual scene is determined according to the information of real object 1.

At S103, the sound of the virtual scene is output based on the sound output effect.

In some embodiments, the information of real object 1 can also include information that affects the acoustic property. The information can include one or more of a size, a material, or a category of real object 1. The acoustic property of real object 1 can be determined through the obtained information of the real object 1.

In some embodiments, the electronic device using the above sound effect processing method can further include an acoustic property management module. The acoustic property management module can store a mapping relationship between real object 1 and the virtual scene. After the information of real object 1 is obtained, the sound output effect corresponding to real object 1 having the mapping relationship with real object 1 can be determined. Then, the sound output effect corresponding to real object 1 and the sound output effect corresponding to real object 2 can be fused to obtain the sound output effect required by the virtual scene. Thus, the sound output effect does not only correspond to virtual object 2. The sound of the virtual scene can be generated in connection with real object 1. In some embodiments, after the sound source in the virtual scene makes a sound, the real object can process the sound in the virtual scene (e.g., reflection and absorption). Thus, the sound output effect processed by the real object can be provided to improve the user immersion experience.

For example, as shown in FIG. 2, after the sound source makes a sound, in the existing technology, the sound output effect of the virtual scene is generated according to the processing of the sound by the virtual object in the virtual scene. For example, the sound output effect of the virtual scene is generated based on the reflection of the virtual object such as the column and ball for the sound. After information about real object 1 being the wall is obtained in the present disclosure, in connection with the reflection or absorption of the wall for the sound of the virtual scene, the sound output effect of the virtual scene can be obtained, which effectively increases the realism of the sound feedback by the virtual environment.

In the present disclosure, the information of real object 1 can be obtained, and the sound output effect of the virtual scene can be determined based on the information of real object 1. The information of real object 1 can include the association relationship between real object 1 and the virtual scene and the acoustic property of real object 1. Thus, the sound output effect of the virtual scene can be adjusted in connection with the real object in the real scene. Thus, the immersion feeling of the user can be enhanced in the virtual scene to effectively increase the realism of the sound feedback in the virtual environment.

The sound effect processing method can be applied to AR gaming scenes, enterprise service scenes, educational and puzzle scenes, etc. For example, in an AR gaming scene, a player can experience various immersive sound effects according to different real environments. In an enterprise service scene, an AR spatial sound effect can be activated in a digital exhibition and a commercial showroom to allow the user to experience different sound effects in various real environments. In an educational and puzzle scene, a participant can wear AR glasses to experience immersive sound effects with a combination of virtual object 2 with real object 1 in connection with various cartoon-style real scenes.

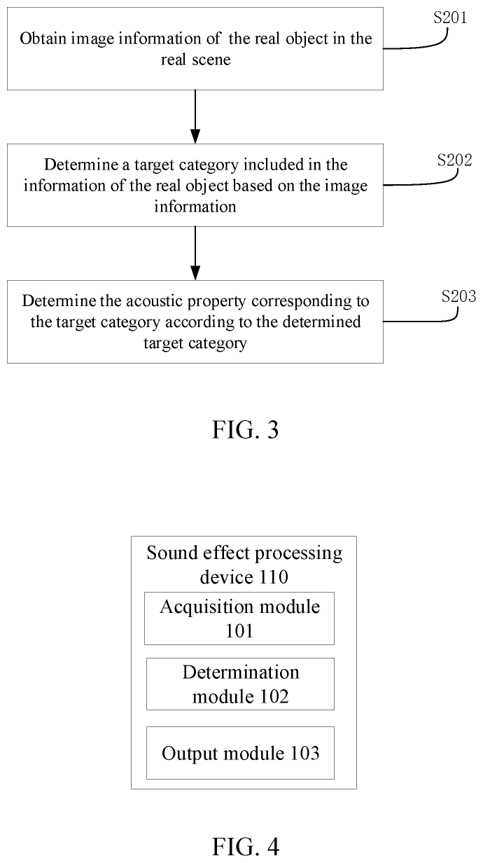

In some embodiments, as shown in FIG. 3, Step S101 of obtaining the information about real object 1 includes steps S201 and S202. At S201, image information of real object 1 is obtained in the real scene. At S202, a target category included in the information of real object 1 is determined based on the image information.

Step S102 of determining the sound output effect of the virtual scene according to the information of real object 1 includes step S203. At S203, the acoustic property corresponding to the target category is determined according to the determined target category.

Thus, the acoustic property corresponding to real object 1 can be determined in connection with the target category included in the information of real object 1. The method of determining the acoustic property can be highly efficient and accurate.

In some embodiments, the image information of real object 1 in the real scene can be collected by the camera of an electronic device or by a depth sensor. The image information can be a two-dimensional image or a three-dimensional depth image, which is not limited in the present disclosure.

In some embodiments, based on computer vision and machine learning software libraries, the obtained image information can be inputted, and the target category corresponding to current real object 1 can be outputted to increase the accuracy of determining the target category corresponding to real object 1. The computer vision and machine learning software libraries can be OpenCV, which is a cross-platform computer vision and machine learning software library distributed under the Apache 2.0 license.

In some embodiments, the target category can include categories by materials, such as metal, wood, etc., categories by properties of the object, such as walls, windows, floors, etc., and categories by size, such as large objects, small objects, etc.

In some embodiments, the target category included in the information of real object 1 determined based on the image information may not correspond to one category and can correspond to a plurality of categories, which are used to accurately determine the properties of real object 1.

In some embodiments, Step S202 of determining the acoustic property included in the information of real object 1 based on the image information can include dividing real object 1 included in the image information to obtain divided images including real objects 1, respectively, and determining the target category of real object 1 based on the divided images.

In some embodiments, Step S203 of determining the acoustic property corresponding to the target category determined according to the determined target category can include determining material information of real object 1 according to the determined target category and determining the acoustic property of real object 1 based on the material information. The acoustic property can at least include one or more of a reflection coefficient and an absorption coefficient of real object 1 for the sound.

Thus, the acoustic property can be further determined in connection with the material information of real object 1 to increase the accuracy in determining the acoustic property.

In some embodiments, the material information can at least include one or more materials forming real object 1 and a parameter of a corresponding material related to acoustic. The material information can be used to determine the acoustic property of real object 1.

In some embodiments, Step S102 of determining the sound output effect of the virtual scene according to the information of real object 1 can include constructing a scene model including the real scene and the virtual scene, obtaining a first characteristic parameter of the sound source in the scene model, and generating the sound output effect of the virtual scene based on the first characteristic parameter of the sound source. The first characteristic parameter can at least include a position parameter.

Thus, the sound output effect of the virtual scene can be determined in connection with the scene model and the position of the sound source. Thus, the sound output effect can be more realistic, which can further improve the immersion experience of the user.

In some embodiments, constructing the scene model including the real scene and the virtual scene can include obtaining depth information of real object 1 in the real scene, determining point cloud information of real object 1 based on the depth information, and generating a virtual scene model including real object 1 and virtual object 2 based on the point cloud information.

In some embodiments, the first characteristic parameter of the sound source can also include pitch, loudness, and timbre of the sound source. The position parameter included in the first characteristic parameter of the sound source can be a coordinate parameter of the sound source or a distance parameter of the sound source relative to real object 1 and/or virtual object 2.

In some embodiments, Step S102 of determining the sound output effect of the virtual scene according to the information of real object 1 can further include determining a second characteristic parameter of real object 1 in the real scene based on the scene mode and generating the sound output effect of the virtual scene according to the first characteristic parameter of the sound source and the second characteristic parameter of the real object in the real scene. The second characteristic parameter can at least include a size parameter.

Since the size parameter of real object 1 affects the reflection or absorption of real object 1 for the sound, the sound output effect of the virtual scene can be generated in connection with the position parameter of the sound source and the size parameter of real object 1 to improve the accuracy of the sound output effect.

In some embodiments, the size parameter of real object 1 can be used to indicate the size of real object 1 in the virtual scene and can include a volume parameter, a length parameter, a width parameter, and a height parameter of real object 1.

In some embodiments, Step S202 of determining the target category included in the information of real object 1 based on the image information can include determining that the information of real object 1 corresponds to at least two categories, determining the probability values corresponding to the categories, using the category corresponding to a highest probability value as the target category of real object 1, or using a category corresponding to at least one property value of the plurality of property values as a sub-category of the target category.

Thus, the target category of real object 1 can be further determined accurately through the property value corresponding to the category to further increase the accuracy of the acoustic property determined based on the target category. For example, the probability of the chair being made of wood is 70%, and the probability of being made of metal is 50%. The category with the higher probability value can be determined as the target category of real object 1. That is, the category of the chair can be determined to be the wood category. The categories corresponding to the plurality of property values can be determined as the sub-categories of the target category. That is, the wood category and the metal category can be used as the sub-categories of the chair.

In some embodiments, the property values corresponding to the categories can include inputting the image information into a first database and obtaining the target category of the real object and the property value corresponding to the target category included in the image information output based on the image information in the first database.

In some embodiments, determining the probability values corresponding to the categories can include inputting the image information into the first database and obtaining the target category of real object 1 the probability values corresponding to the target category included in the image information outputted based on the image information in the first database.

In some embodiments, Step S203 of determining the acoustic property corresponding to the determined target category can include, when the target category includes a plurality of sub-categories, determining the acoustic properties corresponding to the plurality of sub-categories, respectively.

In step S102, determining the sound output effect of the virtual scene according to the information of real object 1 can include determining sub-sound output effects corresponding to the acoustic properties based on the acoustic properties corresponding to the sub-categories and mixing the sub-sound output effects based on a pre-determined ratio to obtain the sound output effect of the virtual scene.

Thus, when the target category includes a plurality of sub-categories, the sound output effect of the virtual scene can be obtained by mixing the determined sub-sound output effects according to the acoustic properties corresponding to the sub-categories. The sound property is not determined only through one target category. Thus, the accuracy of the generated sound output effect can be further improved.

In some embodiments, the predetermined ratio can be related to the probability values corresponding to the sub-categories. That is, the higher the probability value corresponding to the sub-category is, the higher proportion the sub-category takes. The lower the probability value corresponding to the sub-category is, the lower proportion the sub-category takes.

In some embodiments, determining the acoustic property of real object 1 based on the material information can include, when the material information of real object 1 includes different materials, determining coverage areas of the materials on real object 1 based on the image information of real object 1, and determining the acoustic property of real object 1 according to the coverage areas.

Thus, a processing effect of the surface of the real object to the sound can be determined according to the coverage areas of the materials on real object 1 to further determine the acoustic property of real object 1.

In some embodiments, when the material information of real object 1 is determined to include metal and wood materials, a coverage area of the metal material for the chair can be determined to be 15 square centimeters, and a coverage area of the wood material for the chair can be determined to be 5 square centimeters. The acoustic property of real object 1 can be determined based on the different coverage areas of the two materials.

Embodiments of the present disclosure further provide a sound processing device 110. As shown in FIG. 4, the sound processing device 110 includes an acquisition module 101, a determination module 102, and an output module 103. The acquisition module 101 can be configured to obtain the information of real object 1. The information can include the association relationship between real object 1 and the virtual scene and the acoustic property of real object 1. The determination module 102 can be configured to determine the sound output effect of the virtual scene according to the information of real object 1. The output module 103 can be configured to output the sound of the virtual scene based on the sound output effect.

In the present disclosure, by obtaining the information of real object 1, the sound output effect of the virtual scene can be determined based on the information of real object 1. The information of real object 1 can include the association relationship between real object 1 and the virtual scene and the sound property of real object 1. Thus, the sound output effect of the virtual scene can be adjusted in connection with the real object in the real scene, which increases the immersion feeling of the user in the virtual scene and effectively increases the realism of the virtual environment.

In some embodiments, the acquisition module 101 can be further configured to obtain the image information of real object 1 in the real scene and determine the target category included in the information of real object 1 based on the image information. The determination module 102 can be further configured to determine the acoustic property corresponding to the target category according to the determined target category.

In some embodiments, the determination module 102 can be further configured to determine the material information of real object 1 according to the determined target category and determine the acoustic property of real object 1 based on the material information. The acoustic property can include at least one of the reflection coefficient or the absorption coefficient of real object 1 for the sound.

In some embodiments, the determination module 102 can be further configured to construct the scene model including the real scene and the virtual scene, obtain the first characteristic parameter of the sound source in the scene model, and generate the sound output effect of the virtual scene based on the first characteristic parameter of the sound source. The first characteristic parameter can include at least a position parameter.

In some embodiments, the determination module 102 can be further configured to determine the second characteristic parameter of real object 1 in the real scene based on the scene model and generate the sound output effect of the virtual scene according to the first characteristic parameter of the sound source and the second characteristic parameter of real object 1 in the real scene. The second characteristic parameter can at least include the size parameter.

In some embodiments, the acquisition module 101 can be further configured to determine that the information of real object 1 indicating that real object 1 at least corresponds to two categories, determine the probability values corresponding to the categories, using the category corresponding to the highest probability value of the plurality of property values as the target category of the real object 1, or using the category corresponding to at least one probability value of the plurality of probability values as the sub-category of the target category.

In some embodiments, the determination module 102 can be further configured to, when the target category includes a plurality of sub-categories, determine the acoustic properties corresponding to the sub-categories, determine the sound output effect of the virtual scene according to the information of real object 1.

Determining the sound output effect of the virtual scene according to the information of real object 1 can include determining the sub-sound output effects corresponding to the acoustic properties based on the acoustic properties corresponding to the sub-categories and mixing the sub-sound output effects based on the predetermined ratio to obtain the sound output effect of the virtual scene.

In some embodiments, the determination module 102 can be further configured to, when the material information of real object 1 includes different types of materials, determine the coverage areas of the materials for real object 1 based on the image information of real object 1, and determine the acoustic property of real object 1 according to the coverage areas.

Embodiments of the present disclosure further provide a storage medium storing a computer program that, when executed by the processor, causes the processor to perform the steps of the sound processing method.

Units of embodiments of the present disclosure can be implemented as computer-executable instructions stored in the memory that, when executed by the processor, cause the processor to perform the corresponding steps. The units can also be implemented as hardware having corresponding logic computation capability or a combination (firmware) of software and hardware. In some embodiments, the processor can be implemented as any one of FPGA, ASIC, DSP chip, SOC (System on Chip), MPU (such as but not limited to Cortex), etc. The processor can be communicatively coupled to the memory and configured to execute the computer-executable instructions stored in the memory. The memory can include read-only memory (ROM), flash memory, random access memory (RAM), such as synchronous DRAM (SDRAM) or Rambus DRAM, static memory (e.g., flash memory, static random access memory), etc., which store computer-executable instructions in any format. The computer-executable instructions can be accessed and read by the processor from ROM or any other suitable storage location. The computer-executable instructions can be loaded into RAM for the processor to execute to implement the wireless communication method of embodiments of the present disclosure.

In the various members of the system of the present disclosure, the members of the system can be logically divided according to the functions that need to be implemented. However, the present disclosure is not limited to this, the members of the system can be divided or grouped again as needed. For example, some members can be grouped into a signal member, or some embodiments can be further divided into more sub-members.

Embodiments of the present disclosure can be implemented in hardware, in the software module that can run on one or more processors, or in a combination thereof. Those skilled in the art can understand that some or all functions of some or all members of the system of embodiments of the present disclosure can be implemented using the microprocessor or digital signal processor (DSP). The present disclosure can also be implemented and used to perform a portion of the method, all apparatuses, or device programs (e.g., the computer program and the computer program product). The program implementing the present disclosure can be stored in a computer-readable medium or can have one or a plurality of signal forms. The signals can be downloaded from the Internet website, provided at the carrier signals, or provided in any other forms. In addition, the present disclosure can be implemented by the hardware including different elements, and by the appropriately programmed computer. In the listed unit claims of the devices, some devices of the plurality of devices can be embedded through the same hardware item. The words first, second, and third do not represent any sequence and can be understood as names.

Furthermore, although exemplary embodiments have been described in the present specification, the scope can include any and all embodiments with equivalent elements, modifications, omissions, combinations (e.g., solutions across various embodiments), adaptations, or changes. The elements in the claims are broadly interpreted based on the language used in the claims and are not limited to the examples described in the present specification or in the implementation of the present disclosure and are not limited to the examples described in embodiments of the present disclosure. The examples can be interpreted as non-exclusive. Thus, the present specification and the examples are examples. The real scope and spirit can be represented by the following claims and equivalents of the claims.

The above description is intended to be illustrative and not restrictive. For example, the above examples (or one or more solutions) can be used in combination with each other. For example, those skilled in the art may use other embodiments while reading the above description. In addition, in embodiments of the present disclosure, various features may be grouped together to simplify the present disclosure, which should not be interpreted as an intent to require protection for any disclosed feature being necessary for any claim. On the contrary, the subject matter of the present disclosure can have fewer features than all the features disclosed in embodiments of the present disclosure. Thus, the claims can be used as examples or embodiments and integrated into embodiments of the present disclosure. Each claim can be required to be an individual embodiment, and the embodiments can be combined or grouped in various groups or arrangements. The scope of the present disclosure should be determined with reference to the appended claims and the entire scope of equivalents of the claims.

The above embodiments are merely some embodiments of the present disclosure and are not intended to limit the present disclosure. The scope of the present disclosure is defined by the claims. Those skilled in the art can make various modifications or equivalent replacements to the present disclosure within the essence and scope of the present disclosure. These modifications or equivalent replacements are also within the scope of the present disclosure.

What is claimed is:

1. A sound effect processing method comprising:
obtaining an information of a real object, the information including an association relationship between the real object and a virtual scene, and an acoustic property of the real object;
determining a sound output effect of the virtual scene based on the information of the real object; and
outputting sound of the virtual scene based on the sound output effect.

2. The sound effect processing method according to claim 1, wherein:
obtaining the information of the real object includes:
obtaining an image information of the real object in a real scene; and
determining a target category included in the information of the real object based on the image information;
determining the sound output effect of the virtual scene according to the information of the real object includes:
determining the acoustic property corresponding to the target category according to the determined target category.

3. The sound effect processing method according to claim 2, wherein determining the acoustic property corresponding to the target category according to the determined target category includes:
determining a material information of the real object according to the determined target category;
determining the acoustic property of the real object based on the material information, wherein the acoustic property includes at least one or more of a reflection coefficient and an absorption coefficient of the real object to the sound.

4. The sound effect processing method according to claim 1, wherein determining the sound output effect of the virtual scene based on the information of the real object includes:
constructing a scene model including a real scene and the virtual scene;
obtaining a first characteristic parameter of a sound source in the scene model, wherein the first characteristic parameter at least includes a position parameter; and
generating the sound output effect of the virtual scene based on the first characteristic parameter of the sound source.

5. The sound effect processing method according to claim 4, wherein determining the sound output effect of the virtual scene according to the information of the real object further includes:
determining a second characteristic parameter of the real object in the real scene based on the scene model, wherein the second characteristic parameter includes at least a size parameter; and
generating the sound output effect of the virtual scene according to the first characteristic parameter of the sound source and the second characteristic parameter of the real object in the real scene.

6. The sound effect processing method according to claim 2, wherein determining the target category included in the information of the real object based on the image information includes:
determining that the image information of the real object corresponds to at least two categories;
determining probabilities corresponding to categories;
using a category corresponding to a highest probability of the probabilities as the target category of the real object; or
using a category corresponding to at least one probability of the probabilities as a sub-category of the target category.

7. The sound effect processing method according to claim 2, wherein:
determining the acoustic property corresponding to the target category according to the determined target category includes:
in response to the target category including a plurality of sub-categories,
determining acoustic properties corresponding to the sub-categories; and
determining the sound output effect of the virtual scene according to the information of the real object includes:
determining sub-sound output effects corresponding to the acoustic properties based on the acoustic properties corresponding to the sub-categories; and
mixing the sub-sound output effects based on a predetermined ratio to obtain the sound output effect of the virtual scene.

8. The sound effect processing method according to claim 3, wherein determining the acoustic property of the real object based on the material information includes:
determining coverage areas of various materials for the real object based on the image information of the real object in response to the material information of the real object including different materials; and
determining the acoustic property of the real object based on the coverage areas.

9. A sound effect processing device comprising:
one or more processors; and
one or more memories storing a computer instruction that, when executed by the one or more processors, causes the one or more processors to:
obtain information of a real object, wherein the information includes an association relationship between the real object and a virtual scene and an acoustic property of the real object;
determine a sound output effect of the virtual scene based on the information of the real object; and
output sound of the virtual scene based on the sound output effect.

10. The device according to claim 9, wherein the one or more processors are further configured to:
obtain image information of the real object in a real scene; and
determine a target category included in the information of the real object based on the image information;
determine the acoustic property corresponding to the target category according to the determined target category.

11. The device according to claim 10, wherein the one or more processors are further configured to:
determine material information of the real object according to the determined target category; and
determine the acoustic property of the real object based on the material information, wherein the acoustic property includes at least one or more of a reflection coefficient and an absorption coefficient of the real object to the sound.

12. The device according to claim 9, wherein the one or more processors are further configured to:
construct a scene model including a real scene and the virtual scene;
obtain a first characteristic parameter of a sound source in the scene model, wherein the first characteristic parameter at least includes a position parameter; and
generate the sound output effect of the virtual scene based on the first characteristic parameter of the sound source.

13. The device according to claim 12, wherein the one or more processors are further configured to:
determine a second characteristic parameter of the real object in the real scene based on the scene model, wherein the second characteristic parameter includes at least a size parameter; and
generate the sound output effect of the virtual scene according to the first characteristic parameter of the sound source and the second characteristic parameter of the real object in the real scene.

14. The device according to claim 10, wherein the one or more processors are configured to:
determine that the image information of the real object corresponds to at least two categories;
determine probabilities corresponding to categories;
use a category corresponding to a highest probability of the probabilities as the target category of the real object; or
use a category corresponding to at least one probability of the probabilities as a sub-category of the target category.

15. The device according to claim 14, wherein the one or more processors are further configured to:
in response to the target category including a plurality of sub-categories, determine acoustic properties corresponding to the sub-categories; and
determine sub-sound output effects corresponding to the acoustic properties based on the acoustic properties corresponding to the sub-categories; and
mix the sub-sound output effects based on a predetermined ratio to obtain the sound output effect of the virtual scene.

16. The device according to claim 11, wherein the one or more processors are further configured to:
determine coverage areas of various materials for the real object based on image information of the real object in response to the material information of the real object including different materials; and
determine the acoustic property of the real object based on the coverage areas.

17. A storage medium storing a computer program that, when executed by one or more processors, causes the one or more processors to:
obtain information of a real object, wherein the information includes an association relationship between the real object and a virtual scene and an acoustic property of the real object;
determine a sound output effect of the virtual scene based on the information of the real object; and
output sound of the virtual scene based on the sound output effect.

18. The storage medium according to claim 17, wherein the one or more processors are further configured to:
obtain image information of the real object in a real scene; and
determine a target category included in the information of the real object based on the image information;
determine the acoustic property corresponding to the target category according to the determined target category.

19. The storage medium according to claim 18, wherein the one or more processors are further configured to:
determine material information of the real object according to the determined target category; and
determine the acoustic property of the real object based on the material information, wherein the acoustic property includes at least one or more of a reflection coefficient and an absorption coefficient of the real object to the sound.

20. The storage medium according to claim 17, wherein the one or more processors are further configured to:
construct a scene model including a real scene and the virtual scene;
obtain a first characteristic parameter of a sound source in the scene model, wherein the first characteristic parameter at least includes a position parameter; and
generate the sound output effect of the virtual scene based on the first characteristic parameter of the sound source.
